(19) United States
(12) Patent Application Publication
(10) Pub. No.: US 2017/0238316 A1
(43) Pub. Date: Aug. 17, 2017

(54) CONFIGURATION OF A SET OF CARRIERS IN A CARRIER AGGREGATION OPERATION OF A WIRELESS COMMUNICATION SYSTEM

(71) Applicant: Futurewei Technologies, Inc., Plano, TX (US)

(72) Inventors: YING LI, Bridgewater, NJ (US); JIN YANG, Bridgewater, NJ (US)

(73) Assignee: Futurewei Technologies, Inc., Plano, TX (US)

(21) Appl. No.: 15/042,882

(22) Filed: Feb. 12, 2016

(51) Int. Cl. H04W 72/04

(52) U.S. Cl. CPC H04W 72/0453

(57) ABSTRACT

The disclosure relates to carrier aggregation technology for selecting a set of component carriers in a carrier aggregation operation for a user equipment (UE). The disclosure includes a method, a node and a non-transitory computer-readable medium for determining a set of feasible component carrier combinations supported by a node and a capability of the UE. A component carrier combination(s) based on location information corresponding to the UE is predicted or a signal strength(s) received from component carriers is estimated to prioritize a component carrier combination from the set of feasible component carrier combinations. The component carrier combination having a highest priority is then selected from the set of prioritized feasible component carrier combinations.

### BACKGROUND

In wireless communication networks, wireless traffic is increasing at an exponential rate. Not only is the number of user equipment (UE) increasing, but for some UEs, the amount of traffic (e.g., number of bits) per unit of time (e.g., per second) to be communicated is increasing. In particular, applications that demand higher amounts of traffic per unit of time, such as video, high-definition images, and the like, are seeing a significant increase in traffic.

Carrier aggregation is a technology that allows the UE, like a mobile telephone, to use one or more carriers in a wireless communication system, so as to possibly enhance the amount of traffic per unit of time for the UE. A carrier, or carrier wave or carrier signal, is a waveform that is modulated with an input signal for the purpose of conveying information. The carrier signal has an associated bandwidth that is used to convey the information according to the modulation scheme. When a UE uses more than one carrier, the UE can use the total bandwidth of the plurality of carriers. With a larger bandwidth, therefore, a UE may conduct a higher total amount of traffic communicated per unit of time, compared to a UE using a smaller bandwidth, with similar context such as status of channels.

Carrier aggregation enables multiple carrier signals to be simultaneously communicated between the UE and a supporting base station, Typically, the UE may be configured with a set of carriers by a base station, such as an enhanced NodeB (eNB). In some instances, the carriers may be from different frequency bands to add greater bandwidth to support high data rate communications and operations, such as streaming video or large data files.

### BRIEF SUMMARY

In one embodiment, the present technology relates A method for selecting a set of component carriers in a carrier aggregation operation for a user equipment (UE), the method comprising: determining a set of feasible component carrier combinations supported by a node and a capability of the UE; performing one of (a) predicting at least one of the component carrier combinations based on location information corresponding to the UE and (b) estimating one or more signal strengths received from one or more component carriers to the UE to prioritize the component carrier combinations from the set of feasible component carrier combinations; and selecting the component carrier combination having a highest priority in the component carrier combination from the set of prioritized feasible component carrier combinations.

In another embodiment, the present technology relates a node configured to perform a carrier aggregation operation, the node comprising: a receiver configured to receive a capability of a user equipment (UE); and one or more processors in communication with the receiver and storing instructions in a non-transitory memory storage, wherein the one or more processors execute the instructions to: determine the set of feasible component carrier combinations supported by the node and the capability of the UE; perform one of (a) predicting at least one of the component carrier combinations based on location information corresponding to the UE and (b) estimating one or more signal strengths received from one or more component carriers to the UE to prioritize the component carrier combinations from the set of feasible component carrier combinations; and select the component carrier combination having a highest priority in the component carrier combination from the set of prioritized feasible component carrier combinations.

In yet another embodiment, the present technology relates to a non-transitory computer-readable medium storing computer instructions for selecting a set of component carriers in a carrier aggregation operation for a user equipment (UE) in a communication network, that when executed by one or more processors, perform the steps of determining a set of feasible component carrier combinations supported by a node and a capability of the UE; performing one of (a) predicting at least one of the component carrier combinations based on location information corresponding to the UE and (b) estimating one or more signal strengths received from one or more component carriers to the UE to prioritize the component carrier combinations from the set of feasible component carrier combinations; and selecting the component carrier combination having a highest priority in the component carrier combination from the set of prioritized feasible component carrier combinations.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the Background.

### BRIEF DESCRIPTION OF THE DRAWINGS

Aspects of the present disclosure are illustrated by way of example and are not limited by the accompanying figures for which like references indicate like elements.

FIG. 1 illustrates a wireless network for communicating data.

FIG. 2A illustrates an example of carrier aggregation of continuous carriers.

FIG. 2B illustrates an example of carrier aggregation of non-continuous component carriers.

FIG. 3A is a flowchart for selecting a carrier combination according to embodiments of the present technology.

FIG. 3B illustrates four embodiment of a process, used in accordance with the method of FIG. 3A.

FIG. 3C is a flowchart showing prioritizing and estimation/prediction used in accordance with the method of FIG. 3A.

FIG. 4 is a flowchart showing the analytics used in accordance with the method of FIG. 3A.

FIG. 5 illustrates an embodiment of a virtual grid.

FIG. 6 illustrates an embodiment of a virtual grid, using measurement information and location information.

FIG. 7 illustrates an embodiment of another virtual grid, using location information.

FIG. 8 illustrates an embodiment of a radio network node and a user equipment in a wireless communication system.

FIG. 9 illustrates a block diagram in accordance with the process depicted in FIGS. 3A-3C and 4.

FIG. 10 illustrates a block diagram of a network system that can be used to implement various embodiments.

### DETAILED DESCRIPTION

The present technology, generally described, relates to carrier aggregation technology, where a set of carriers is configured for use for communications with user equipment (UE). The configuration of carriers for the UE is done using analytics and data, in which the analytics include predictions and estimations and the data includes measurement reports from the UE, where the data may include current and historical data. Additionally, location related information of the UE may be accessed to assist in the analysis. The analytics used in embodiments of the present disclosure will help to reduce and/or eliminate inter-carrier or inter-frequency measurements performed by the UE to perform carrier aggregation, and will thereby achieve fast carrier aggregation.

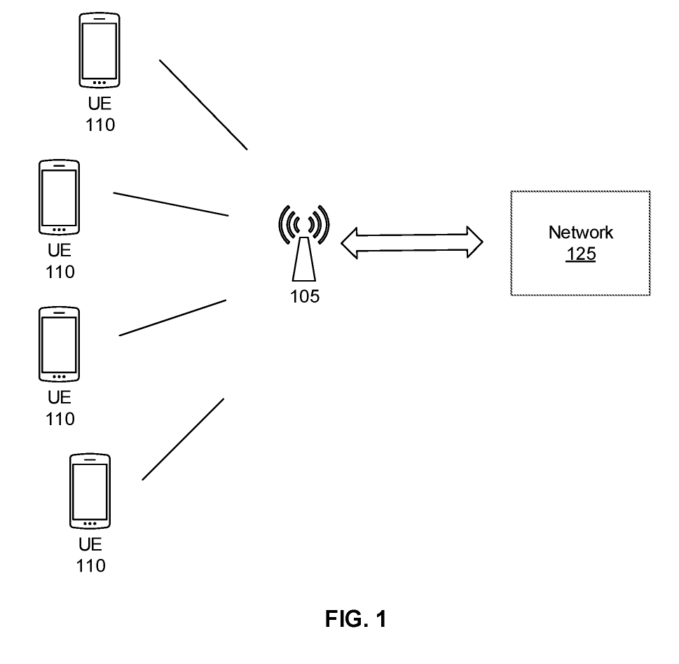

FIG. 1 illustrates a wireless network for communicating data. Network 125 includes an access node, such as an eNB 105 that supports bidirectional communications within a cell coverage area with a plurality of UEs 110. Although four UEs 110 are depicted, it is appreciated that the illustration is non-limiting in the number that may be provided. UEs 110 may be any component capable of establishing a wireless connection with eNB 105 such as cell phones, smart phones, tablets, sensors, etc. In some embodiments, the network 125 may include various other wireless devices, such as relays, etc. eNB 105 may be any component capable of providing wireless access by establishing uplink (UL) and/or downlink (DL) connections with UEs 110, such as a base station (BS), a NodeB, an access point, a transmit point (TP), and other wirelessly enabled network access devices. There may also be device-to-device (D2D) communications between UEs 110. It is noted that an eNB 105 may support communications within one or multiple cells, each having one or multiple sectors. In some embodiments, a sector may be operated as a cell. For purposes of simplicity, in this disclosure, an eNB 105 and a cell can be interchangeable, unless specifically mentioned otherwise.

In one embodiment, the eNB 105 comprises a carrier aggregation component (not shown) that is configured to provide service for a plurality of UEs and, more specifically, to select and allocate carriers as aggregated carriers for a UE. More specifically, the carrier configuration component of eNB 105 is configured to receive or determine a carrier aggregation capability of a selected UE. The carrier aggregation component operating at the eNB 105 is operable to configure a plurality of component carriers at the eNB 105 for the selected UE based on the carrier aggregation capability of the selected UE. Based on the selected UE(s) capability or capabilities, the eNB 105 is configured to generate and broadcast a component carrier configuration message containing component carrier configuration information that is common to the plurality of UEs that specifies aggregated carriers for at least one of uplink and downlink communications. In another embodiment, eNB 105 generates and transmits component carrier configuration information that is specific to the selected UE to the selected UE. Additionally, the carrier aggregation component may be configured to select or allocate component carriers for the selected UE based on at least one of quality of service needs and bandwidth of the selected UE. Such quality of service needs and/or required bandwidth may be specified by the UE or may be inferred by a data type or data source that is to be transmitted.

Examples of a wireless network that can implement the present techniques and systems include, among others, wireless communication systems based on Code Division Multiple Access (CDMA) such as CDMA2000 1×, High Rate Packet Data (HRPD), Long-Term Evolution (LTE), LTE-advanced (LTE-A), 5-th generation (5G) cellular systems, Universal Terrestrial Radio Access Network (UTRAN), and Worldwide Interoperability for Microwave Access (WiMAX). It is appreciated that the illustrated embodiment is non-limiting, and that any number of various wireless devices and telecommunication systems may be employed, as readily appreciated to the skilled artisan.

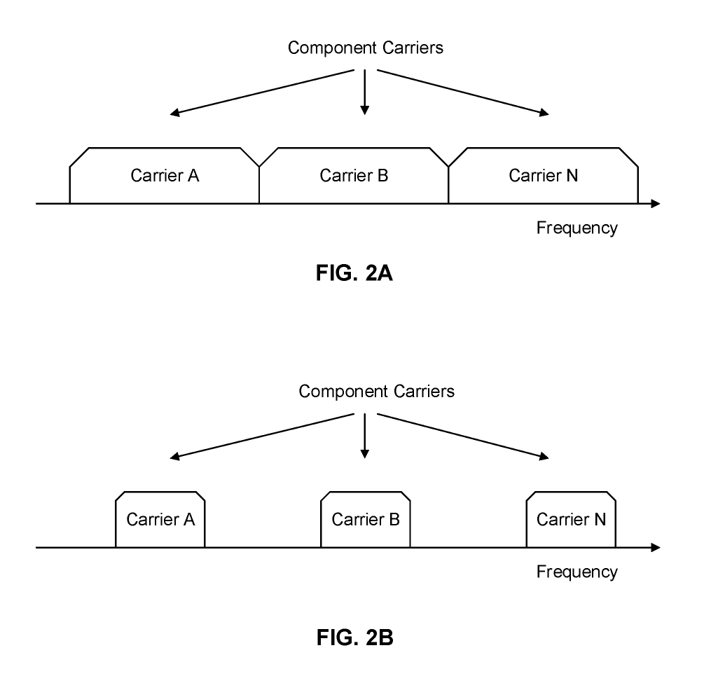

FIG. 2A illustrates an example of carrier aggregation of contiguous carriers. In the example, three carriers (carriers A, B and N) are contiguously located along a frequency band. Each carrier can be referred to as a component carrier. In a contiguous type of system, the component carriers are located adjacent one another and are typically located within a single frequency band. A frequency band is a selected frequency range in the electromagnetic spectrum that are designated for use with wireless communications such as wireless telephony.

FIG. 2B illustrates an example of carrier aggregation of non-contiguous component carriers. The non-contiguous component carriers (carriers A, B and N) may be separated along the frequency range, and each component carrier may be located within a same frequency band, or in different frequency bands. The ability to use component carriers in different frequency bands enables greater communication speeds and more efficient use of available bandwidth. It is appreciated that carriers may also be referred to as bands, frequency bands, etc., and that each aggregated carrier may be referred to as a component carrier (CC).

Additionally, carrier aggregation can make use of the carriers, which may be contiguously allocated within a same operating frequency band, or non-contiguously within a same operating frequency band or different operating frequency bands, possibly in a more efficient way. As channel statuses for a UE on one or multiple carriers may vary due to factors such as the UE's mobility, time-varying conditions along the communication paths, it is of importance to configure a UE with a set of carriers in a fast manner, to ensure the UE to have a good set of carriers for its communication need, as well as the resources on the carriers are utilized efficiently.

When carrier aggregation is used there are a number of serving cells for a UE. For example, one cell can be for each component carrier for the UE. The coverage of the serving cells may differ, for example, due to that CCs on different frequency bands will experience different pathloss. The radio resource control (RRC) connection is handled by one cell, the Primary serving cell, served by the Primary component carrier (PCC). In idle mode, the UE listens to system information on the downlink PCC. The other component carriers are all referred to as Secondary component carriers (SCC), serving the Secondary serving cells. The SCCs are added and removed as required, while the PCC is only changed at handover.

The carrier configuration for a UE which uses carrier aggregation is UE specific. The UEs may have different PCCs and SCCs, even if these UEs are close to each other or under a similar coverage by cells. A PCC for a first UE may be a SCC for a second UE. The component carriers or the cells configured for a UE for CA operation can be from a same site (a same eNB), or from more than one sites (more than one eNB). Throughout the disclosure, unless specifically mentioned otherwise, a component carrier and a carrier can be interchangeable. In certain embodiments, for example when one cell is for each component carrier for a UE, a component carrier, a carrier, and a cell for a UE can be interchangeable, unless specifically mentioned otherwise.

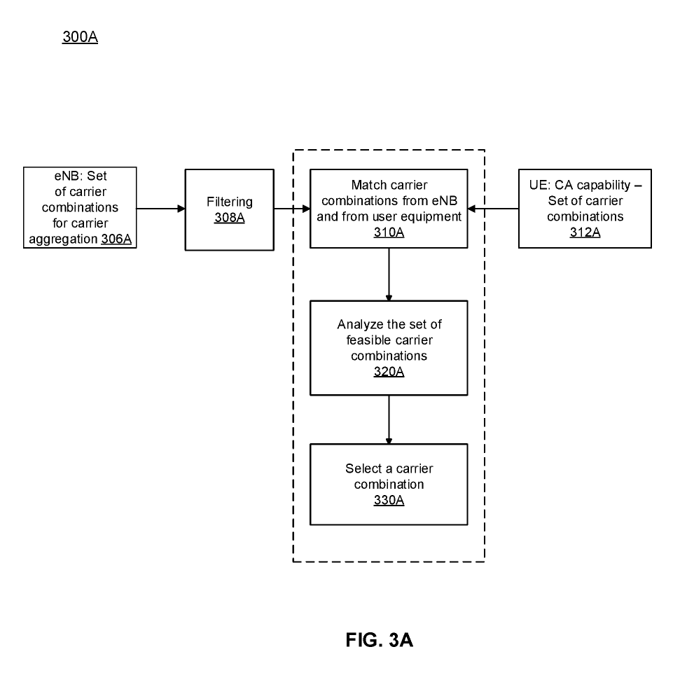

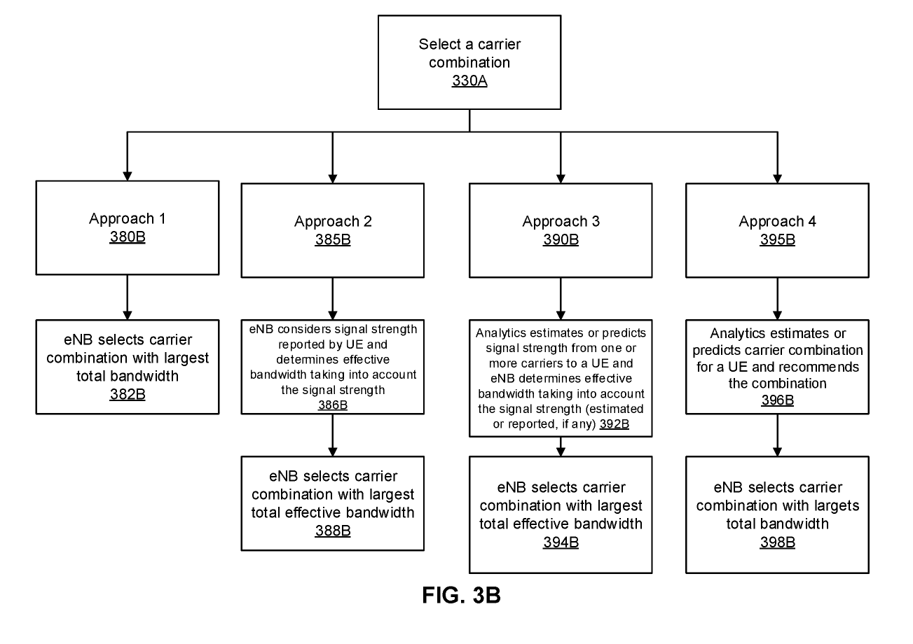

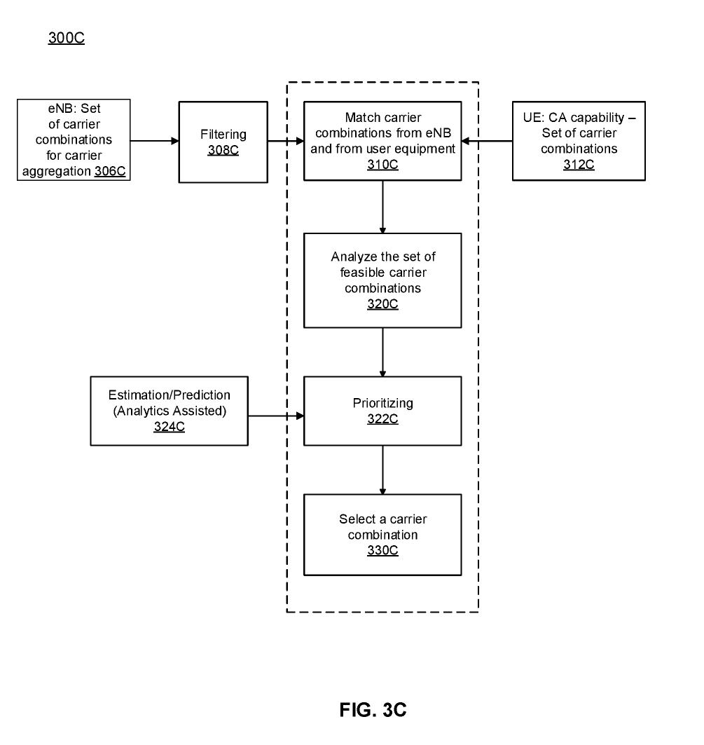

FIG. 3A is a flowchart showing a method for selecting a carrier combination according to embodiments of the present technology. The flowchart 300A will be described herein with reference to FIG. 1. An eNB 105 stores a list of supported carrier combinations that may be used for carrier aggregation at 306A. The list may be based on its own configuration, as well as the configurations of neighboring eNBs. The carrier combinations supported by different eNBs may be different, depending on factors such as whether the hardware of the eNB supports a certain band or frequency carrier, whether there is certain limitation of certain carriers being PCC or SCC, and the like. Similarly, the UE 110 (FIG. 1) may also store a list of UE capable carrier combinations that can be used for carrier aggregation at 312A. A discussion of carrier combination lists is detailed below. The carrier combinations herein can be the component carrier combinations.

According to one embodiment, the carrier combinations can be extended to cell combinations. In this case, the UE 110 may report the UE's capability about the carrier combination to the eNB 105. In response, the eNB 105 can use the reported information to determine the cell combination for the UE's capability from the UE 110 reported carrier combination. The eNB may use the information of which cell uses which carrier, together with the information from the UE 110 on UE supported carrier combinations, to determine the cell combinations that UE supports. Similarly, the eNB's list of carrier combinations can be detailed into a listing of cell combinations. The information of which cell uses which carrier can be communicated via the network 125. When a cell is for a component carrier, the component carrier combinations can be the cell combinations. The cells can include, for example, the neighboring cells and the serving cells.

The combination of carriers can be for both PCC and SCC. The carrier used by the UE for attachment to the eNB 105 can be considered the initial and default carrier, or the PCC. All other carriers used by the UE can be SCCs. For example, with reference to FIG. 2A, carrier A in the combination can be for PCC, and the other carriers (carriers B and N) can be for SCC for a UE. Moreover, it is appreciated that a combination of carrier A+carrier B can be different from the combination of carrier B+carrier A, if the first carrier in the combination is for the PCC, while the other remaining carriers are for the SCCs for a UE. In some embodiments, the combinations can be for SCCs, then different ordering of the SCCs in a carrier combination may mean the same combination, and the PCC for a UE can be the current cell which may not show in the carrier combination.

At 308A, the list of eNB supported carrier combinations may be filtered to reduce the list of carrier combinations, or reduce the carriers in the combination. Carrier combination factors may include, but are not limited to, carrier loading, UE capability, signal strength/path loss for a carrier/grid combination, carrier bandwidth and bandwidth totals and historical data for a carrier with respect to signal strength. The filtering can be based on, for example, the load of a cell, the barring of a cell, and the like. For example, the filtering can exclude carriers having a load meeting or exceeding a threshold (e.g., component carriers whose corresponding cells are overloaded). The filtering may also exclude carriers whose corresponding cells are barred. For example, at 306A, the set of eNB supported carriers combinations includes A+B, B+C and A+D. Further, if it is known that carrier A is overloaded, carrier A is filtered out of the carrier combinations in the list at 308A. If carrier A corresponds to the PCC in the carrier combination (e.g., the first carrier is PCC in a carrier combination), then the combinations A+B, and A+D are filtered out of the list of carrier combinations at 308A. The set of eNB supported carrier combinations, post filtering at 308A, will be reduced to B+C, because the combinations including carrier A are filtered out. Additionally, carrier combinations that are no longer supported by the network may also be filtered out.

The list of the eNB 105 supported carrier combinations may then be matched with the UE 110 capable carrier combinations at 310A, such that the eNB 105 may derive a set of matching carrier combinations. For example, the list of the eNB 105 supported carrier combinations include A+B, A+C and D+E. The list of UE 110 capable carrier combinations includes A+B, A+C and F+G. Therefore, after these two sets are matched, it is determined that the set of matching carrier combinations is A+B and A+C. For purposes of this disclosure, the set of matching carrier combinations may be referred to as a feasible set of the carrier combinations for the UE 110. It is noted that the filtering 308A may optionally be after the matching of the eNB 105 supported carrier combinations and the UE 110 capable carrier combinations 310A. Hence, the feasible set of carrier combinations can be the output after the filtering. In this case, the feasible set of carrier combinations is the set of carrier combinations supported by the eNB, supported by the UE's capability, and post the filtering of carriers based on factors such as load, availability, and the like. In another embodiment, the feasible set of carrier combinations may be the output after the matching 310A, followed by filtering 308A (in other words, the filtering may be an operation for a feasible set of carrier combinations).

In one embodiment, the feasible set of carrier combinations (e.g., when the feasible set is for both PCCs and SCCs, where the first carrier in the combination is PCC, and remaining carriers in the combination is SCCs), can imply that carrier combinations which have fewer carriers than the carrier combinations in the feasible set are also feasible with the same PCC, even if they may not be listed in the feasible set. For example, when carrier combination A+B+C is in the feasible set of carrier combination (e.g., A is a PCC; B and C are SCCs), then carrier combination A+B, A+C are also feasible, although they may not be explicitly listed in the feasible set. In this case, if A is filtered (removed) due to being overloaded, for example, then the combination A+B+C should be filtered, as A is a PCC, and it implies that A+B, A+C are filtered (removed). If B is filtered out due to being overloaded, for example, then A+C are not removed, but A+B+C, A+B are removed. Thus, filtering or removing a carrier if the carrier is a PCC will remove all of the carrier combinations with the carrier being PCC. Filtering or removing a carrier if the carrier is an SCC may still keep the combination with the PCC and other SCCs in the combination. If a carrier is to be removed due to reasons such as the signal strength from the carrier to the UE is below certain threshold, it will follow a similar rule, depending on whether the carrier is PCC or SCC.

In another embodiment, the feasible set of carrier combinations (e.g., when the feasible set is for SCCs, not including PCC), can imply that carrier combinations that have fewer carriers than the carrier combinations in the feasible set are also feasible, even if they are not listed in the feasible set. For example, carrier combination A+B+C is in the feasible set of carrier combination, then carrier combination A+B, A+C, B+C are also feasible, even though they may not be explicitly listed in the feasible set.

At 320A, the eNB 105 analyzes the carrier combinations. The carrier combinations can be analyzed using each carrier's bandwidth. In an alternative embodiment, the carrier combinations can be analyzed using an effective bandwidth, which can be estimated by the carrier's bandwidth, signal strength of the carrier, and the like. In another embodiment, the carrier combination can be analyzed using estimated signal strength that is predicted, for example, by the eNB 105 (possibly also the network 125) based on various measurements and reports generated by the UEs 110 (the UE for which the eNB is to configure carriers, and other UEs which may or may not need to use carrier aggregation). The estimated signal strength of a carrier can then be used in estimating the effective bandwidth of the carrier. The analysis for carrier combinations may also exclude or remove one or more carriers from a carrier combination if the reported signal strength or estimated signal strength is lower than a certain threshold. In one embodiment, measurements from a UE for which the eNB is to configure carriers, and other UEs may be received at the eNB 105. In one aspect, the data may include performance measurements such as network coverage and service quality and location data for the device.

Upon receipt of the measurement data, relevant performance data and/or device location data may be obtained or generated from the received data. For example, a UE 110 may transmit performance measurement data such as but not limited to, the average received signal code power (RSCP) for Universal Mobile Telecommunications System (UMTS), or reference signal received power (RSRP), reference signal received quality (RSRQ), average block error rate for voice service, and wireless device Tx Power etc., along with location data. In one aspect, location data may include explicit location information, such as latitude and longitude and/or altitude, computed by a mobile device using reference signals and/or other information obtained from a system, such as but not limited to, a satellite system (e.g. GPS) or terrestrial network (e.g. Time of Arrival, Time Difference of Arrival or Angle Difference of Arrival), or a combination of the satellite and terrestrial network (e.g. Network-assisted GPS) or the like. In another aspect, location data may include measurements reported by the UE, from which the network 125 can compute the location of a UE. Other methods of measurement may also be employed, as understood by the skilled artisan.

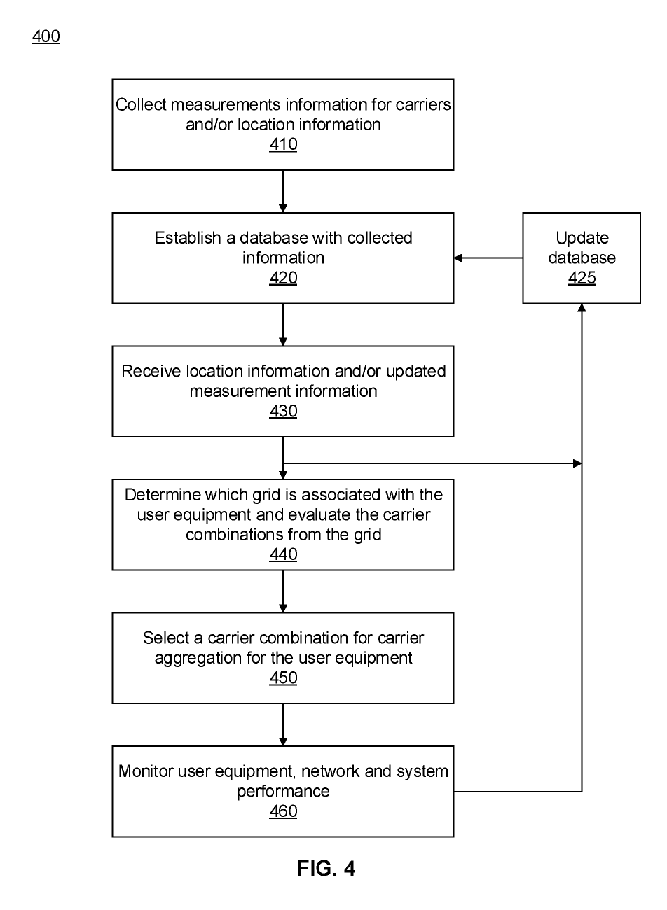

The data analytics may use these measurements (and/or previously collected measurements or historical data) along with an estimated carrier signal strength to perform an analysis of the carrier combinations to determine which carrier combination provides the strongest effective signal strength. Such analysis may also be referred to as data analytics, which analysis is described in more detail below with reference to FIG. 4.

At 330A, the eNB 105 selects a carrier combination based on the set of matched carrier combinations. For example, the selected carrier combination may be the carrier with the largest total bandwidth among each of the carrier combinations in the feasible set. The eNB 105 can configure the carriers in the selected carrier combination to the UE 110. When the eNB 105 configures the carriers to the UE 110 for carrier aggregation operation, if certain carrier(s) in the selected combination are already configured, then the eNB 105 can configure those carrier(s) that are not yet configured.

FIG. 3B illustrates four techniques used to select a chosen carrier combination. Selecting a chosen carrier combination (330A) may be executed according to one of the following techniques, herein referred to as approaches 1-4. However, it is appreciated that the disclosure is not limited to the disclosed techniques.

According to a first approach (approach 1) at 380B, the eNB 105 may choose a carrier combination providing the largest total bandwidth compared to each of the other carrier combinations in the feasible set of carrier combinations, at 382B. In this approach, the eNB 105 may not consider whether the signal strength of a carrier in the carrier combination is greater than a threshold.

Once the eNB 105 selects the carrier or cell combination, the eNB 105 may configure the UE 110 to measure or send measurement reports for a subset or all of the carriers in any of the carrier combinations. If the signal strength for a carrier is higher than a threshold, the eNB 105 configures the carrier to the UE 110. The resulting configured carriers may be a subset of or all of the carriers in the chosen combination.

If the carriers in the chosen combination have sufficient signal strength quality to satisfy a threshold requirement (e.g., having a reference signal received power (RSRP) or reference signal received quality (RSRQ) satisfying a threshold, or signal to noise ratio (SNR), signal to interference ratio (SIR), signal to interference and noise ratio (SINR) satisfies a certain criteria), the selected combination may not be the carrier combination that provides the largest total bandwidth. That is, the chosen carrier combination (referred to herein as an effective carrier combination) may not be the carrier combination with the largest total bandwidth. For example, a UE's capability may support three combinations: (1) combination 1: carrier A+B+C+D; (2) combination 2: carrier A+B+E; and (3) combination 3: carrier A+C+F, where each carrier has a frequency bandwidth of 20 MHz. The carrier combinations may also be provided in the list of supported carrier combinations of the eNB 105.

For combination 1, carriers A+B+C+D (each at 20 MHz) provide the highest bandwidth of the three combinations at 80 MHz (20 MHz*4 carriers (carriers A, B, C, D)). For purposes of the example, and according to the UE's measurements, the RSRPs of carriers A, B, E are above a threshold, while the RSRPs of carriers C, D, F are below the threshold. Thus, when the carrier combinations are measured, including those carriers that are above the threshold, and not including those carriers that are below the threshold, combination 1 measures at 40 MHz, combination 2 at 60 MHz and combination 3 at 20 MHz. Accordingly, combination 2 is selected as the carrier combination with the highest effective frequency at 60 MHz. Notably, although combination 1 has the highest bandwidth, it does not have the highest effective bandwidth (highest bandwidth for carriers whose RSRP are above the threshold), and therefore combination 2 is selected as the carrier combination with the highest effective bandwidth.

According to a second approach (approach 2) at 385B, the eNB 105 may consider the signal strength of the carriers and determines an effective bandwidth taking into account the signal strength at 386B when it selects a carrier or cell combination from the set of feasible combinations. The set of feasible combinations in this approach is a result of matched eNB 105 supported carrier combinations and the UE capable combinations, after the eNB 105 supported carrier combinations were filtered at 308A (FIG. 3A). At 388B, the eNB 105 selects a carrier combination which has the largest total effective bandwidth.

If the UE's 110 measurement report of the signal strength of the carriers is available when selecting a carrier combination, the eNB 105 can select the carrier combination that provides the largest total bandwidth. Selection of the carrier combination in this regard considers the carriers having a signal strength (e.g., RSRP or RSRQ) that are higher than the threshold (i.e., the most effective carrier combination). The carrier's bandwidth is counted if the signal strength from carrier (cell) to the UE 110 (by UE's measurement on the carriers) is greater than a threshold, otherwise, the carrier's bandwidth is not counted. In other words, the carrier with a signal strength lower than a threshold is removed from the carrier combination which is left with few carriers in the combination. If the UE's 110 measurement report of the signal strength of the carriers is unavailable when selecting a carrier combination, the eNB 105 may configure the UE 110 to perform measurements of the carriers.

Once the UE 110 performs the measurements and reports the measurements to the eNB 105, the eNB 105 can determine whether the signal strengths of the carriers are higher than the threshold. The eNB can configure the carrier combination to the UE. Using approach 2, for the example aforementioned, combination 2: carrier A+B+E, which has the highest bandwidth for the carriers whose RSRP are higher than the threshold will be chosen, not combination 1: carrier A+B+C+D.

In an alternative embodiment, the effective bandwidth can be estimated using certain expressions or by a lookup table. For example, the effective bandwidth can be estimated by W*log(1+SINR), where W is the bandwidth of a carrier (e.g., 20 MHz), SINR is the signal to interference and noise ratio, which can be obtained e.g., via RSRP, measurement on interference and noise (IN), where SINR=P/(P+IN), where P can be from the RSRP. In another example, the effective bandwidth can be W*f(SINR), where f(SINR) is a mapping of SINR to a factor, and the mapping can be in a format of a lookup table. This method multiplies a factor related to the signal strength to the carrier bandwidth. This method can be combined with the method where the carrier is removed from a combination if the signal strength is lower than a threshold.

According to a third approach (approach 3) at 390B, the UE's 110 measurement reports of some or all of the carriers are unavailable. Thus, in this approach, the eNB 105 may estimate or predict the signal strength of one or more carriers, and determine an effective bandwidth taking into account the signal strength (reported if UE 110 reports are available, or estimated) of the carriers at 392B. The estimation or the prediction can be implemented using an analytics module. The analytics can recommend carriers based on the estimated or predicted signal strength (for example, the analytics can recommend carriers whose estimated or predicted signal strength is higher than a certain threshold). The analytics may also estimate signal strength of some (one or multiple) carriers, depending on the capability of the analytics module and available information.

For example, if historical data is available regarding the signal strength from a carrier to a UE 110 or other UEs at a certain location, then the historical data can be used to estimate the signal strength of this carrier. The historical data may include the information of the type of UEs. The type of UE can be related to the UE's maker, model, capability, and the like. The type of UE may also be classified, e.g., in a manner that the UEs of a same type or similar type can be using a same or similar carrier configurations for CA operation, if these UEs are at a same or nearby location. For example, at a certain location, at certain times in the past, there can be other UEs (e.g., assume two UEs, UE_a in UE class 1 and UE_b in UE class 2) which reported the signal strength from a carrier C. UE_a may be of similar or the same type as UE 110. UE_b may be a different type than UE 110, such that the configuration of carriers or carrier combination for CA operation could be very different for UE_b and UE 110.

Continuing with the example, when UE 110 enters the location that UE_a and UE_b were previously located, and signal strengths of carrier C to a UE in UE class 1 and a UE in UE class 2 are in the historical data, the signal strength recorded or stored for UE_a (class 1) can be used to estimate the signal strength from carrier C to UE 110. If the historical data already includes the signal strength from carrier C to UE 110 at this particular location (or a nearby location), the signal strength recorded for UE 110 can also be used to estimate or predict the signal strength from carrier C to UE 110.

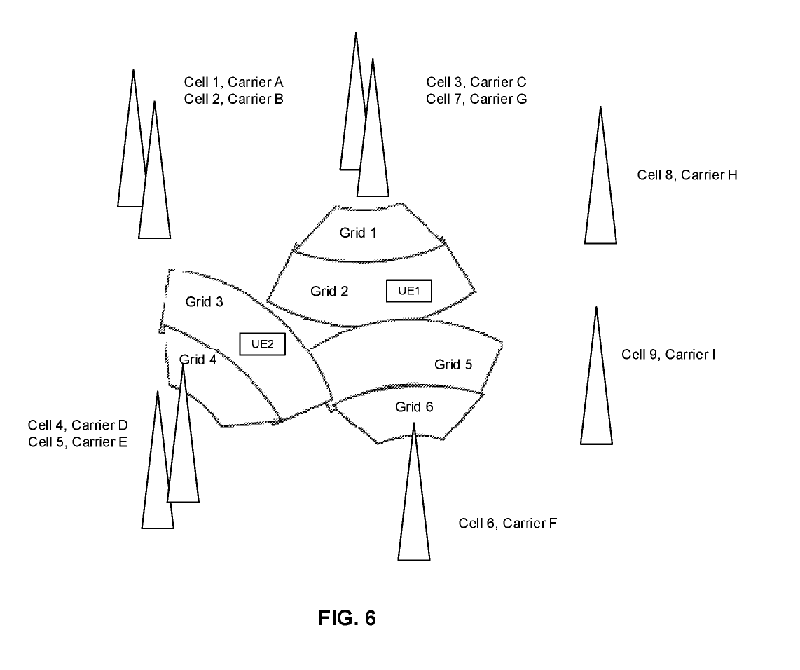

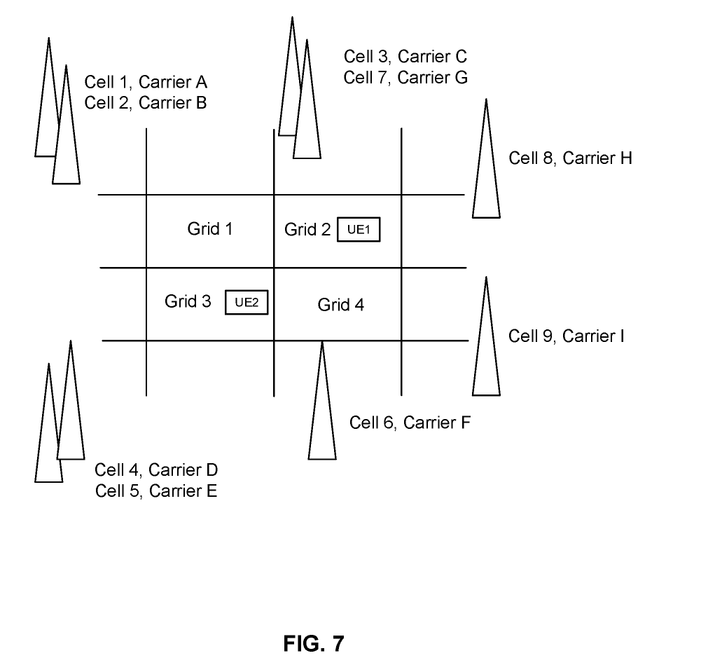

As an alternative, the UE's type of class may not be considered in the analytics performed. Hence different UEs may have similar experiences about wireless channels regarding the signal strength of a carrier if these UEs are at a same or nearby location, i.e., the signal strengths from a carrier to the UEs may be within a range for these UEs in same or nearby location. The same or nearby location can be within a grid or a grid element (e.g., the grid introduced as in FIGS. 6-7 below). The analytics can also recommend carriers that the UE 110 should perform measurement on, and the eNB 105 can configure the UE 110 to perform measurement and reporting accordingly. For example, if for a carrier, there is no historical data available regarding the signal strength from a certain carrier to a UE 110 or other UEs at a certain location, then the UE 110 can be configured to measure the signal strength of this carrier.

In another example, the UE 110 can be configured to measure one or more carriers. The measurements (i.e., measurement reports) from the UE 110 on these carriers can be used in analytics to estimate or predict the other carriers in the carrier combinations. For example, if there are 7 carriers in the carrier combinations in the feasible set, the UE 110 can be configured to measure 3 of the carriers. The measurement reports from these 3 carriers can be used in the analytics to predict or estimate the other 4 carriers signal strength. The measurement reports of the 3 carriers signal strength may be used as the input pattern to match and determine the signal strength with respect to each of the remaining 4 carriers, or the measurement reports of the 3 carriers signal strength may be used as an estimation of the UE's location. Then, using the location, the analytics can estimate the signal strength with respect to each of the remaining 4 carriers. For example, the measurement reports of the 3 carriers signal strength or the path loss may be used as the input to estimate the location of the UE using localization method such as triangulation, and once estimated location of the UE is determined, the respective distance from the UE to the remaining 4 carriers can be estimated. Based on the respective estimated distance, the path loss with respect to each of the remaining 4 carriers can be estimated, and the signal strength from each of the remaining 4 carriers can be estimated (e.g., the received signal strength can be the sum of transmit power and antenna gain of each component carrier (or the cell) minus the path loss, plus the UE receiver gain.

The eNB 105 may select the carrier combination with a largest total effective bandwidth at 394B. For example, the eNB 105 selects the carrier combination that provides the largest total bandwidth over the carriers having a reported or estimated signal strength (e.g., RSRP or RSRQ) that are higher than a given threshold. The eNB 105 selects the carrier combination, then configures the combination to the UE 110. The eNB 105 may also configure the UE 110 to measure certain carriers if the estimated signal strength is larger than a certain threshold. In this case, after receiving the UE's 110 measurement reports, the eNB 105 can use the reported UE 110 measurement on the signal strength of carriers instead of the estimated ones, and further select the carrier combination from the good carrier combinations which are recommended, for example, it selects the carrier combination with the largest effective bandwidth taking into account the reported UE 110 measurement on signal strength of the carriers.

For example, if the UE's 110 measurements are not available at the time of selecting the carrier combinations for carrier aggregation, the eNB 105 may estimate the signal strength of the carriers using analytics (described below with reference to FIG. 4). The eNB 105 selects the carrier combination providing the largest total bandwidth with the carriers having reported (or estimated if no report is available) signal strengths (e.g., RSRP or RSRQ) higher than the threshold. The eNB 105 may then configure that combination to the UE 110, and select the carrier combination. In one embodiment, the estimated signal strength may be obtained by prediction. For example, the prediction may be based on learning and data analytics (described in FIG. 4), in which the learning and data analytics may use grids, such as a virtual grid. These virtual grids may include an index corresponding to each grid (or grid element), where each indexed grid may store a signal strength or signal strength range of the carriers (or cells) that a UE in the grid may use to detect and perform measurements and reports.

In an alternative embodiment, instead of estimating or predicting the signal strength, an estimation or prediction of whether the signal strength is higher than a threshold may be used. In this embodiment, the virtual grid may store the carrier indices if the carrier strength is higher than the threshold. Grids may be stored in a storage system of the network 125 that is accessible by the eNB 105 and UE 110, or stored on the eNB 105 or UE 110, or any other storage component accessible over the network. In another alternative embodiment, the analytics can estimate or predict the effective bandwidth for a carrier combination. The analytics can then recommend the best or good carrier combinations, according to the effective bandwidth values (the higher the better). The eNB 105 may configure the UE 110 to measure certain carriers if the carrier appears in the recommended carrier combination. After receiving the UE's 110 measurement reports, the eNB 105 can further select the carrier combination from the good carrier combinations which are recommended, for example, the eNB 105 selects the carrier combination with the largest effective bandwidth taking into account the reported UE 110 measurement on signal strength of the carriers.

According to a fourth embodiment (approach 4) at 395B, the eNB 105 configures carrier combination recommended by analytics for the UE 110. The analytics can estimate or predict carrier combinations for a UE, and recommend the combinations 396B. The eNB 105 can select, at 398B, the carrier combination with the total bandwidth, or total effective bandwidth, among all the recommended combinations. For example, historical data may show a pattern for a UE at a certain location being good carrier combinations of combination 1 and combination 2. If combination 1 has a total bandwidth of 40 MHz, combination 2 has a total bandwidth of 60 MHz, then combination 2 is chosen.

An algorithm may be used to estimate, based on an obtained prediction, which carrier combinations should be used by the UE 110 for carrier aggregation. The historical data may include the information of the type of UEs. The type of UE can be related to the UE's maker, model, capability, and the like. The type of UE may be classified, e.g., in a manner that the UEs of a same type or similar type can be using a same or similar carrier configurations for CA operation, if these UEs are at a same or nearby location. For example, at a certain location, at certain times in the past, there can be other UEs (assume e.g., two UEs, UE_a in UE class 1, UE_b in UE class 2) whose carrier combinations in CA operation were recorded (assume UE class 1 has carrier combination 11, and UE class 2 has carrier combination 12). UE 110 may be of UE class 1, not class 2.

When UE 110 arrives at the location that UE_a and UE_b were previously located, the carrier combinations recorded or stored for UE class 1 can be used to estimate or predict or recommend the carrier combinations or carriers for UE 110. If the historical data already includes carrier combinations for UE 110 at this particular location (or nearby location), the signal strength recorded for UE 110 can also be used to estimate or predict the carrier combinations for UE 110.

As an alternative, the UE's type of class may not be considered in the analytics performed. Hence different UEs may have similar experiences about wireless channels regarding the carrier combinations if these UEs are at a same or nearby location, i.e., the carrier combinations for the UEs may be within a set for these UEs in same or nearby location. The same or nearby location for these UEs can be within a grid or a grid element (e.g., the grid introduced as in FIGS. 6-7 below). The carrier combinations within one grid element can be a common set that is supported by this grid element. This set may be the same or a subset of the set of carrier combinations supported by an eNB 105 if the grid element is within the coverage of the eNB 105, or it can be different from the set of carrier combinations supported by the eNB 105 if the grid element is also covered by other eNBs. The carrier combinations supported by UE's capability can be then checked for each individual UE, if the UE is located in this grid element, against the grid supported carrier combinations, such that the carrier combinations both supported by the UE and the grid are considered further for recommendation or prediction or estimation of the carriers or carrier combination to be configured to the UE for CA operation.

In one embodiment, the combination of the carriers that have a signal strength higher than a threshold may be selected in the carrier combination. The estimates obtained by predictions may be based on learning and data analytics, which can use the virtual grids that store the carrier combinations. The virtual grid may be used to recommend, estimate and predict the carrier or cell combinations for the UE for carrier aggregation.

FIG. 3C is a flowchart showing prioritizing and estimation/prediction used in accordance with the method of FIG. 3A. Similar to FIG. 3A, an eNB 105 stores a list of supported carrier combinations that may be used for carrier aggregation at 306C and the UE 110 stores a list of UE capable carrier combinations that can be used for carrier aggregation at 312C.

For the set of feasible carrier combinations, the carrier combinations may be prioritized such that the best combination for the UE 110 is selected. An estimation or prediction based on learning and data analytics is used to assist the prioritization. The prioritization can be, for example, the best total bandwidth of the carriers whose signal strength is higher than a threshold, or the best total bandwidth of the carriers whose signal strength is higher than a threshold based on the measurement report (if available) or the estimated/predicted measurement report or signal strength, assisted by the analytics, or the best total bandwidth of the component carriers or cells whose signal strength is higher than a certain threshold based on the measurement report if available, or the carriers or cells that recommended or predicted for the UE by the analytics if the measurement report is not available; or the best total bandwidth of the carriers or cells that the analytics would recommend or predict for the UE. The bandwidth could be the actual bandwidth, such as 5 MHz, 10 MHz or 20 MHz of the carrier, or an effective rate which can be a function of the bandwidth and the signal strength (e.g., B*log(1+SINR), where B is the bandwidth and SINR is the signal to interference plus noise ratio, which may be converted from the measurements, such as RSRP, RSRQ, etc.). Based on the prioritization, the best combination for the UE 110 is selected.

At 308C, the eNB 105 determines if any of its carriers are overloaded. If a carrier is overloaded, the overloaded carrier(s) is filtered from the list of supported carrier combinations of the eNB 105 at 308C. If the carriers are not overloaded or after the overloaded carriers have been filtered out at 308C, the set of carrier combinations at the eNB 105 (306C) is matched at 310C with a set of carrier combinations capable for the UE 110 (312C). The matching set of carrier combinations is referred to as the feasible set.

In an alternate embodiment, the estimations/predictions based on the data analytics can be used to assist in the filtering. If the carrier combinations are not recommended by a virtual grid, then they can be filtered out. Further, the estimations and predictions based on data analytics can be used to assist in the matching, at 310C, wherein the carrier combinations not recommended by a virtual grid may not be included in the feasible set.

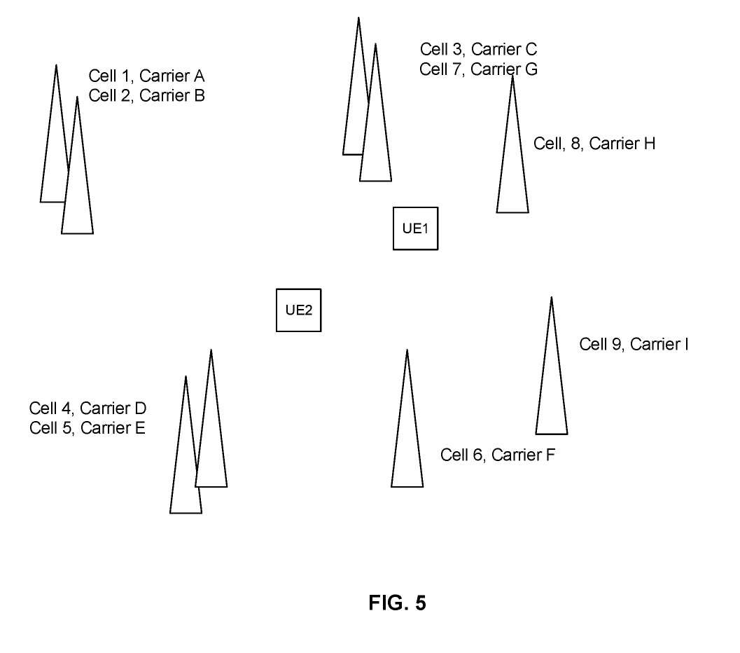

In one embodiment, the eNB 105 may perform a prioritizing of the carrier combinations to select the best carrier combination for the UE 110 at 322C, by accessing information stored on virtual grids and grid libraries (discussed below with reference to FIGS. 5-7). In another embodiment, at 324C, an estimation and/or a prediction based on the analytics may be used to determine the signal strength of a carrier and/or the location of a UE 110. At 320C, if there are any signal strength predictions or estimates, or any historical or location information that can be used via a virtual grid (as described in reference to FIGS. 5-7), that information is used to determine signal strengths of the carriers in the feasible set. If analytics are used to determine measurements, the UE 110 may optionally be instructed to measure only the signal strengths of the carriers with no estimates, predictions or data. In another embodiment, the UE 110 does not make any measurements, even if there is no specific data, because the analytics make a prediction based on the virtual grids, grid libraries and any other data. If there are no predictions or estimates, the UE 110 optionally measures the carrier signal strengths in the feasible set. Both the prioritizing at 322C and the estimation/prediction 324C are used to assist the eNB 105 in selecting the carrier combination at 330C. Using analytics for calculating signal strength measurements for each carrier, instead of the UE 110 performing measurement for each carrier, may result in advantages such as an increased savings in the time to select the carrier combination (by not having to wait for the reports from UE 110), and savings in UE's energy consumption. As an alternative, the prioritizing 322C and analytics 324C can be moved to be after, amongst other places, filtering 308C and before matching 310C.

The grids, as discussed in further detail below, can be learned using measurement reports and locations of UEs from historical data, as well as the respective combinations of the carriers (or cells) within a virtual grid. The UEs include, for example, the UE 110 that is to be configured with carriers or combination of carriers for CA operation, the other UEs in the system, where the other UEs may or may not support CA operation. The historical data can be used to generate a library for the grids. Further, a map of the grids may be configured or formed.

FIG. 4 is a flowchart 400 showing an embodiment of analytics used in accordance with the method of FIGS. 3A and 3C. Although the process in FIG. 4 is performed at the eNB 105 in the disclosed example, it is noted that the process may also be performed at other network components, such as a self-organized-network (SON) server (not illustrated). If the process of FIG. 4 is performed at an SON server, the SON server may communicate with the eNB 105 about a variety of issues, such as, but not limited to, related analytics results, such as the prediction or estimation results, as well as an interchange of the information such as the data collected at the eNB 105. In an alternative embodiment, the process described in FIG. 4 may be partially carried out at the eNB 105 and partially carried out at the SON server. For example, 420, 425 and 440 may be carried out at the SON server, and 410, 430, 450 and 460 may be carried out at the eNB 105, while the SON server and the eNB 105 communicate with one another regarding information, such as, but not limited to, data, results, and the like.

At 410, the eNB 105 or a network node (e.g., a SON server) collects historical data, including the data from UEs where the UEs may have CA operation. For example, the historical data can include, for example, the measurement reports from the UEs, location information, respective UE CA combinations if the UE has CA operation, information of the carriers, and the like. These UEs may not necessarily be the same UE as the one which is to be configured with carriers or combination of carriers at a current time, rather, they can be UEs that are served by the network in the past, hence the historical data are collected.

At 420, the eNB 105 or a network node establishes database or library, to have a grid map, based on the historical data collected at 410. Grids are discussed below with reference to FIGS. 5-7. The measurement and location information, as well as the carriers or carrier combinations, may be used to establish (create) a database by the eNB 105, or a network node, at 420. The stored measurement and location information, as well as the corresponding carriers or carrier combinations in the database may be referred to herein as a grid library. Grid maps, such as the grid maps shown in FIGS. 5-7 can be generated at 420. The steps 410 and 412 can be, for example, performed in an offline manner.

At 430, the eNB 105 or a network node receives location information or some measurement reports, from a UE 110, to which the carriers or carrier combination is to be configured for its CA operation.

A part of the measurement reports may also be used to identify or determine which grid the UE 110 is in, where the measurement reports may be related to some of the carriers (or cells) that the grid would have information for. The grid library can also recommend carrier (or cell) combinations, where the UE 110 does not need to perform measurements of all of the carriers that are associated with the grid. The UE 110 not performing the measurements of all of the carriers allows for carrier aggregation in a fast manner.

Location information can also be used to determine which grid the UE 110 is in. For example, if the UE's 110 location is known to the eNB 105, the location information can be used to figure out which grid the UE 110 is in. The UE's 110 location may be known using a GPS or using other related information.

At 440, a grid for the UE 110 is identified and the carrier combinations are identified based on, for example, the grid library and/or grid mapping. The combinations related to the grid are used to assist in the selection of carriers for carrier aggregation using, for example, predictions and estimations. Based on the grid related information, filtering of the cells (e.g., load, etc.), UE capability, measurement reports, etc., the selected carrier combination is identified at 450. The selected carrier combination, as a result of the applied analytics, has the most effective bandwidth of the carriers (or cells) in the list supported by the eNB 105, the list of UE capable combinations and is recommended or estimated/predicted by the grid. It is appreciated that the selected carrier combination does not include carriers or cells filtered out due to, for example, overload. The operations in 430, 440, 450 can be performed in an online manner, where the online collected data in 430 can be used together with the offline formed grid (by steps 410, 420), hence which grid (or grid element) the UE 110 is in can be determined (possibly using estimation and prediction), a set of carriers or a set of combinations of carriers can be formed based on the determined grid, and the prioritization and final selection of the carriers or combination of carriers can be performed at 450.

The grid library and the grid map, can be updated when necessary from time to time at 425. For example, if a new location for a UE 110 is found with new carrier combinations and conditions, the new location could be added to the grid as a new grid element. The grid can also be updated, at 425, for example, when a new carrier (or cell) combination is found or a new set of conditions to identify a grid element. The information received at 430 may lead to an update of the library and the grid map.

The performance of the system (or components in the system, such as the network or UE) can also be monitored at 460 by eNB 105. In one embodiment, the monitoring can trigger an update to the grid at 425. In an example, the system may perform worse when using the recommendations from the grid than when the system uses a temporary configuration (e.g., a new recommendation using combinations for some grid elements). In this example, the system may be updated with the new recommendations at 425, where the new configuration replaces the current recommendation and the grid library is updated. Timers and conditions can also be applied to the grid to prevent the grid from going back and forth between two configurations. A condition can be placed, for example, when the performance is higher than the previous performance by a certain threshold, or for at least a timed duration. The new configuration can then replace the old configuration in the grid or grid library.

The recommendations from the grid can be an estimation based on a prediction that accounts for the mobility of the UE 110. For example, when the UE 110 is moving from one grid to another grid, the mobility of a UE 110 may be calculated. In one example method of calculating mobility, the mobility may be calculated as it relates to the transmit power of a pilot signal transmitted from the UE 110. In this regard, an estimated size of the cell can be gained from the pilot signal power and may be used a as a weighting factor to adjust the time spent in a cell to account for its size, such that moderated values for each cell are an indication of mobility.

It is appreciated that the recommended combinations from different grids may vary since the carrier combinations for carrier aggregation can be configured differently. For example, additional rules may apply, if the primary component carrier (PCC) is included in the combination, while the secondary component carrier (SCC) can be reconfigured as needed.

Table 1, as shown below, is an example of a grid based library for carrier or cell combinations for carrier aggregation.

TABLE 1

| | Carrier Combination | |
|---|---|---|
| | supported | Features |
| Grid 1 | One or multiple | Set 1 of conditions of UE location, |
| | combinations for Grid 1 | measurement reports, etc. |
| Grid 2 | One or multiple | Set 2 of conditions of UE location, |
| | combinations for Grid 2 | measurement reports, etc. |
| Grid 3 | One or multiple | Set 3 of conditions of UE location, |
| | combinations for Grid 3 | measurement reports, etc. |
| Grid 4 | One or multiple | Set 4 of conditions of UE location, |
| | combinations for Grid 4 | measurement reports, etc. |
| . . . | . . . | . . . |

In an embodiment, for different mobility categories, different grid and carrier combination mappings can be configured. For example, Table 1 may describe a mobility category for a UE in which the carrier combination and features for each grid are stored. A cell can be identified, but is not limited to, a physical cell ID, carrier index, combinations of these two and others.

Table 2 is another example of a grid based library used for carrier aggregation. UEs 110 with different mobility may have different carrier combinations, even when they are in the same grid, as shown below in Table 2.

TABLE 2

| | Carrier Combination supported | Features |
|---|---|---|
| Grid 1 | One or multiple combinations for | Set 1 of conditions of UE |
| | Grid 1, mobility category 1 | location, measurement |
| | One or multiple combinations for | reports, etc. |
| | Grid 1, mobility category 2 | |
| | One or multiple combinations for | |
| | Grid 1, mobility category 3 | |
| Grid 2 | One or multiple combinations for | Set 2 of conditions of UE |
| | Grid 2, mobility category 1 | location, measurement |
| | One or multiple combinations for | reports, etc. |
| | Grid 2, mobility category 2 | |
| | One or multiple combinations for | |
| | Grid 2, mobility category 3 | |
| . . . | . . . | . . . |

In the network for carrier aggregation, multiple cells may be co-located. For example, a cell can be jointly identified by a physical cell identity (PCID) and a carrier index, such as a value assigned to each carrier. For example, cell 1, cell 2, cell 3 and cell 4 can be identified as PCID=1, carrier index=A; PCID=2, carrier index=A; PCID=2, carrier index=B; PCID=3, carrier index=C; and PCID=4, carrier index=D, respectively. In this example, cell 1 and cell 2 have the same carrier index, but different PCIDs. In another example, cell 1, cell 2, cell 3, and cell 4 can be identified as PCID=1, carrier index=A; PCID=2, carrier index=B; PCID=3, carrier index=C; and PCID=4, carrier index=D, respectively. In this example, the cells have different PCIDs and different carrier indices. In one embodiment, if these cells have different carrier indices, a carrier index can be used to identify each of the cells.

FIG. 5 illustrates an example of carrier aggregation in accordance with the present technology. The figure illustrates multiple carriers A-I and user equipment UE1 and UE2. In this example, cells 1-9 use carriers A-I, respectively. For purposes of simplicity, each of carriers A-I represent a different cell, transmit node or eNB. For example, carriers A and B in the diagram are co-located (e.g., located in the same sector, or located in different sectors but in a same eNB), and carriers C and G and carriers D and E are respectively co-located.

As noted above, a cell may be identified by a PCID, a carrier index, etc. For purposes of the example that follows, each cell has a different carrier index. However, it is appreciated that the disclosure is not limited to the cells having different carrier indices. For example, for different cells, the carrier index may be the same, while the PCID may be different. Additionally, it is appreciated that one or more carriers or cells can be supported by an eNB 105. These carriers or cells may (or may not) be co-located. Thus, for example, if the carriers are not co-located, but belong to the same eNB 105, those carriers could be transmit points of the eNB 105.

In the example of FIG. 5, showing carrier or cell combination selection for carrier aggregation, the eNB 105 has a list of supported carrier combinations. In the example, the eNB 105 supported carrier combinations are: A+B+D+E; A+B+F; B+E+F+G; C+G+H; D+G+H; C+H+I; and F+I. If a cell, for example on carrier C, is determined to be overloaded, any carrier combination including carrier C will be filtered from the list (removed from the list). Thus, for eNB 105 supported carrier combinations, the carrier combinations C+G+H and C+H+I will be filtered out of the list of supported carrier combinations. The resultant, filtered list would be: A+B+D+E; A+B+F; B+E+F+G; D+G+H and F+I. Assume UE1 has a list of capabilities for different carrier combinations as follows: A+B+D+E; C+G+H; D+G+H; E+I; and F+I.

After filtering the eNB 105 list of supported carrier combinations, the eNB 105 supported carrier combinations are matched with the UE1 capable combinations to form a set of matched carrier combinations (namely, the feasible set). That is, the feasible set includes carrier combinations that remain in the list for each of the eNB 105 and UE1, such that each carrier combination in the eNB matches a carrier combination in the UE1, and vice versa. After matching the combinations, the feasible set is therefore reduced to: A+B+D+E; D+G+H and F+I.

As an example, assume that each carrier has a frequency bandwidth of 20 MHz. Also, assume that carriers A, B and E signal strength is not high enough for UE1 (e.g., the signal strength from cells 1, 2, 5 to UE1 is below a certain threshold), and that the location of UE1 is not known but that some measurement reports are available. Each of the four approaches described above will be applied with reference to Table 3 for the example of FIG. 5. In Table 3, assume the inter-frequency measurement takes a duration d (including a gap or any other delays in scanning) for each carrier at different frequency.

TABLE 3

| | | | | Total band- |
|---|---|---|---|---|
| | | Number of | Latency | width of |
| | | carriers which | due to | configured |
| | | need to | inter- | carriers |
| | | perform | frequency | whose signal |
| | | measure- | measure- | strength >= |
| | Combination | ment/report | ment | THR |
| Approach 1 | A + B + D + E | 0 | 0 | 20 MHz |
| Approach 2 | D + G + H | 7 carriers | 7 * d | 60 MHz |
| Approach 3 | D + G + H | 3 carriers | 3 * d | 60 MHz |
| (analytics | | | | |
| assisted) | | | | |
| Approach 4 | D + G + H | 0 | 0 | 60 MHz |
| (analytics | | | | |
| assisted) | | | | |

Applying the first approach, combination A+B+D+E has the largest bandwidth at 80 MHz (20 MHz×4 carriers). Therefore, the combination is selected as the carrier combination. In this approach, as explained above, no measurements are performed. However, the actual total bandwidth from the combination is 20 MHz, since carriers A, B and E do not have enough signal strength to reach UE1.

Applying the second approach, the UE1 performs measurements on each of the carriers. For example, since there are seven carriers in the feasible set of the combinations, the UE1 may be instructed to perform seven measurements on the seven carriers. The measurements may then be reported to the eNB 105. However, since the signal strength from carriers A, B and E to UE1 is below a certain threshold, combination 2 (D+G+H) provides the highest total bandwidth of 60 MHz (20 MHz×3 carriers), such that the selected carrier combination is combination 2.

Applying the third approach, the location of the UE1 is not known. However, some of the UE1 measurement reports are available to the eNB 105. For example, although seven carriers exist in the feasible set of the carrier combinations, the UE1 may be instructed by the eNB 105 to measure only three of the carriers. The UE1 520 measurement reports may then be used to by the eNB 105 to determine in which grid the UE1 is located (for example, the virtual grid shown in FIG. 5). Once the location on the grid is known, the recommended combination can be found by the eNB 105.

For example, assuming that the recommended combination is combination 2 (D+G+H), this combination is the selected carrier combination. If more than one combination is recommended, for example, combination 2 (D+G+H) and combination 3 (F+I), then the combination with the higher total bandwidth can be selected. For example, combination 2 (D+G+H) measures at 60 MHz (3 carriers×20 MHz) and combination 3 (F+I) measures 40 MHz (2 carriers×20 MHz), such that combination 2 (D+G+H) is selected as the carrier combination. Using this approach, the UE1 then performs measurements and reports on the three carriers, where the combination results in a total of 60 MHz.

In another method for the third approach, the UE1 measurement reports on the three carriers can be used to estimate the signal strengths of the other four carriers to UE1, and the carrier combination can be then chosen based on the reported signal strengths from the three carriers, and the estimated signal strengths from the four carriers, as well as using the carrier combinations recommended by the grid if the grid UE1 is in could be determined by the signal strengths reported and estimated. For example, it chooses the combination which is in the recommended combination by the grid, and which has the highest effective bandwidth where the carriers with signal strength higher than a certain threshold are counted.

Applying the fourth approach, the location of the UE1 is assumed to be known. If the virtual grid recommends combination 2 (D+G+H) to the eNB 105, then combination 2 becomes the selected carrier combination. If more than one combination is recommended (e.g., combination 2: D+G+H and combination 3: F+I), then the combination with the higher total bandwidth is selected. Thus, the UE1 does not need to make any measurements or reports, and the total bandwidth for the selected carrier combination will be 60 MHz.

The measurements and reporting of different carriers requires the UE1 to perform inter-frequency scanning. For example, for each inter-frequency scan the UE1 scans one band or carrier frequency, taking a duration d (including a gap or any other delays in scanning). The latency due to inter-frequency measurement and reporting can be proportional to the number of carriers which the UE1 uses to perform measurements and reporting. The measurements, and reports generated by the measurements, are then utilized as detailed above.

FIG. 6 illustrates an embodiment of a virtual grid for carrier or cell combinations for carrier aggregation. As depicted, the grid system includes coverage areas, such as grids 1-6. The grid may be formed, for example, using the measured information or reports generated using the measured information, as explained below.

The coverage areas for a grid are virtually decomposed into sectors that are defined radially and angularly from a network element, such as an eNB 105. In one embodiment, the size of the grids 1-6 can be configured. The size of the grids can assist in determining a balance between the granularities of coverage information on the one hand and processing complexity and storage requirements on the other hand, wherein smaller sectors typically provide for greater granularity, and larger sectors typically provide for decreased processing complexity and storage requirements. In one embodiment, the grids are sized uniformly radially and angularly over the coverage areas, while in other embodiments geographic points of interest may have grids with varying size. For example, if an area has historical coverage problems, smaller sectors may be used in that area to attempt to more closely locate trouble spots.

As illustrated, a first eNB may be connected to one or more UEs, such as UE 1, located in grid 2. A second eNB may be connected to one or more UEs, such as UE2, located in the grid 3. As noted above, UE1 and UE2 can collect raw performance measurements of network coverage and service quality and provide performance measurements to the eNB. The performance measurements can include, for example, physical cell identification of detected cells, signal strength of detected cells, and location information (e.g. identification of a grid) of UE at the time when the performance measurement was sent to the eNB.

Based on the measurement information, the eNBs can determine coverage statistics for their respective UEs. The coverage statistics can be computed per sector for each measurement quantity: probability density function (PDF) or cumulative distribution function (CDF) of signal quality, maximum signal quality, minimum signal quality, average signal quality, and standard deviation of the signal quality. The coverage statistics can also include average RSCP (UMTS)/RSRP (LTE), average block error rate for voice service, and maximum UE Tx Power for voice service. Additionally, other coverage statistics can be computed in the same fashion based on the UE's performance measurements, such as the number of different UEs, the number of signaling connections etc. The performances of the UE, or the network (eNBs) can be used to update the grid data base, the grid map, such as the conditions on the signal strength of the cells for each grid, conditions on the UE mobility (e.g., high, medium, low mobility) for each grid, the recommended cell or carrier combinations, and the like.

In the example of FIG. 6, the grid may be formed based on the measurement reports or a measured set of conditions, such as the signal strength (e.g., RSRP, RSRQ) of nearby carriers or cells. The grid can be formed by the historical data, including, e.g., the measurement reports from the UEs (UE1, UE2, and other UEs which are served by the network in the past), the UEs mobility, location, serving carriers, signal strength of the serving carriers and neighboring cells, combination of the carriers for CA operation, and the like. The current or the most recent status of the UE (e.g., UE1), such as the current or the most recent measurement report, UE's location, mobility, and the like, can be used to determine which grid the UE is in, by looking up to the grid library, or grid mapping. For example, if UE1's recent conditions satisfy the features or conditions set for Grid 1, then, the eNB can determine that UE1 is in Grid 1. Table 4 is an example of a grid based library for carrier or cell combinations for carrier aggregation formed from the virtual grid of FIG. 6.

TABLE 4

| | Carrier | |
|---|---|---|
| | Combination | |
| | supported | Features |
| Grid 1 | A + B + D + E | Set 1 of conditions of |
| | C + G + H | measurement reports |
| Grid 2 | C + G + H | Set 2 of conditions of |
| | D + G + H | measurement reports |
| Grid 3 | A + B + F | Set 3 of conditions of |
| | B + E + F + G | measurement reports |
| Grid 4 | A + B + D + E | Set 4 of conditions of |
| | D + G + H | measurement reports |
| Grid 5 | C + H + I | Set 5 of conditions of |
| | F + I | measurement reports |
| Grid 6 | F + I | Set 6 of conditions of |
| | | measurement reports |
| . . . | . . . | . . . |

In one example, a single grid can be for a single cell such that the combinations in the grid map are the combinations supported by cell and neighboring cells. However, more than a single grid can be used for single cell. Additionally, a combination of UE location and measurement reports can be used in the library for grids for carrier or cell combinations for carrier aggregation.

When mobility of the UE1 is considered, an element in the grid can be predicted, for example, using the measurement reports and UE's moving speed and trajectory based on historical data. The grids can be updated using measurement reports and/or the UE location history, as well as the respective combinations of the carriers within a virtual grid. The historical data can be used to generate the libraries for the grids, which may be stored in a storage system or database in network 125, or in any other component in the network 125 capable of storing such information. The map of the grids, as shown in FIGS. 5-7, can be configured, formed and updated, accordingly.

An example of UE mobility follows. In the example, with reference to FIG. 6, UE1 moves from grid 1 to grid 5. After matching the eNB 105 supported combinations and the UE capable combinations (310A/C of FIGS. 3A and 3C), the feasible set for UE1 results in the following: A+B+D+E; D+G+H; and F+I.

When applying the first approach, UE1 will use the combination A+B+D+E, which results in none of the carriers in the carrier combination have a strong enough signal. Thus applying the second approach, UE1 will perform measurements to generate a measurement report on the carriers. The resulting measurement indicates that carriers A, B, D, E and G are not strong enough (e.g., the signal strength below a certain threshold), and that carriers F and I include strong signals. Therefore, combination F+I is selected as the carrier combination.

Applying the third approach, when UE1 is in grid 1, it uses combination D+G+H. However, when UE1 is in grid 5, F+I becomes a possible combination, because a grid index for grid 5 may have a record of F+I as a possible strong carrier combination. However, D+G+H is not a possible combination since grid 5 may not support carriers D and G. For example, the eNB 105 (or network) may predict that UE1 will move to grid 5 because the measurement reports for carriers D, G or H indicate that the signal strength is not strong enough to reach UE1. The eNB 105 (or network) will then switch the carrier aggregation to F+I for the UE1, located in grid 5.

If the measurement report of D, G, H is not sufficient for the prediction or the estimation of the UE1's grid update, the eNB 105 (or network) can instruct the UE1 to conduct additional measurement reports on carrier F or I. For example, the eNB or network can instruct the UE1 to perform a measurement on carriers D, G and F. If the prediction can be further simplified, for example, by using location information, the UE1 may not need to perform any further measurement reports for the grid update. Instead, the UE1 can determine stored or recorded information on the combination of carriers based on the location using a grid library from the stored database.

A comparison of the fourth approach to the first three approaches is shown in Table 5 below for carrier or cell combination selection for carrier aggregation, for the example shown in FIG. 6.

TABLE 5

| | | | | Total band- |
|---|---|---|---|---|
| | | Number of | Latency | width (MHz) |
| | | carriers which | due to | of configured |
| | | need to | inter- | carriers |
| | | perform | frequency | whose signal |
| | | measure- | measure- | strength >= |
| | Combination | ment/report | ment | THR |
| Approach 1 | A + B + D + E | 0 | 0 | 0 |
| Approach 2 | F + I | 7 carriers | 7 * d | 40 MHz |
| Approach 3 | F + I | 3 carriers | 3 * d | 40 MHz |
| (analytics | | | | |
| assisted) | | | | |
| Approach 4 | F + I | 0 | 0 | 40 MHz |
| (analytics | | | | |
| assisted) | | | | |

In the first approach (Approach 1), the carrier combination (A+B+D+E) with the largest bandwidth is selected. In the second approach (Approach 2), the UE1 performs measurements on seven different carriers and determines that five of the carriers do not have a signal strength that is strong enough. Therefore, using this approach, the carrier combination (F+I) with signal strength higher than a threshold is chosen. The delay, 7×d, is caused by the UE1 making seven inter-frequency measurements.

In the third approach (Approach 3), the eNB 105 predicts that the UE1 will move to Grid 5, for example, by using the measurements reports of D, G, and H. In Grid 5, it has a record of F+I as a possible combination, but not D+G+H. Hence, the eNB 105 or the network will switch the CA to F+1 for the UE1. If the measurement report of D, G, H is not sufficient for the prediction or the estimation of the UE1's grid update, additional measurement report on carrier F or I can be instructed to the UE by the network. For example, the eNB/network can instructed the UE to perform the measurement on carrier D, G, and F. Although the prediction of the UE1 moving to grid 5 may be accurate, the UE1 is still instructed to perform three inter-frequency measurements.

In the fourth approach (Approach 4), the eNB 105 predicts that the UE1 will move to Grid 5, for example, by using location information if it is available. By tracking the location of the UE1, and by predicting its trajectory, the eNB 105 or the network can predict that UE1 will move to Grid 5. Hence, the UE1 should not need to perform any further measurement report for the grid update. Rather, the eNB 105 or the network can find out the stored or recorded information on the combination of carriers based on the predicted grid element where the prediction utilizes the UE1's location. Table 5 shows that using approach 4, the UE1 does not make any inter-frequency measurements and therefore, an effective carrier combination is chosen in a fast manner compared to each of the other approaches.

FIG. 7 illustrates another embodiment of a virtual grid using the geographic location. The geographic location can be related to, e.g., the coverage areas of the network, the location of the cells, and the like. In a coverage area of a network, a network management module can divide the coverage area to grid elements, where the dividing is based on the geographic location. For example, for a coverage area of M cells, assume the area occupies R*R square-feet, then the area can be divided to N*N grid elements or N*N grids, where each grid element (R/N)*(R/N) square-feet, and each grid element covers an area that is a portion of the whole coverage of these M cells, based on the geographic location. In alternative embodiments, the area of the grids may be divided such that each grid element can be of regular shape (e.g., square, rectangle, and the like), or irregular shape.

In the example as shown in FIG. 7, the grid is formed using location data. Location data may be obtained, for example, using a GPS or latitude/longitude coordinates or using any other mechanism readily understood by the skilled artisan to collect location information. After the grid is formed, the grid library or the grid mapping can store the information of the supported carrier combinations for each grid. The supported carrier combinations can be those considering the combinations supported by the cells or eNBs. The grid library or the grid mapping can store the necessary information which helps the recommendation, estimation, prediction of the carriers or carrier combinations for UEs to be configured with carriers, when the UEs are in a respective grid element. The information can also be based on historical data, such as location information of UEs, information of the type of UE, respective carrier combinations for grid elements, and the like.

For example, in historical data, at a certain time point, the location of a UE (assume UE0, not shown in the figure) is determined. Based on UE0's location, and the how the grid is formed, UE0 can be determined to be in which grid (assume UE0 is in Grid 2 at the time point). The carrier combinations used by this UE is also determined by the eNB (assume from the history, when UE0 is in Grid 2, the best carrier combination is C+G+H, then, the database or the grip mapping can record or store the information that UE0 in Grid 2 has best combination as C+G+H). The grid library or grid mapping may capture UE0 as the type of UE0 (such as UE0's maker, model, capability, and the like), or an identifier for the type of UE0, instead of the identifier of UE0. Then, later on, UE1 comes to Grid 2, and UE1 happens to be of the same type as UE0, or of a type close to the type of UE0 so that they may use the same or similar carrier combinations, the grid can recommend the best carrier combinations that UE0 has used in the past, C+G+H, to UE1. The virtual grids depicted in FIGS. 5-7 may also be placed upon one another to cross-reference and obtain a more accurate prediction or result of carrier information. The method mentioned in this embodiment can be combined with other embodiments (e.g., the embodiment aforementioned).

Table 6 illustrates an example of a grid based library for carrier or cell combinations for carrier aggregation. The grid is formed, in one embodiment, using the location information of the area and cells or eNBs, using the virtual grid depicted in FIG. 7. The grid library or the grid mapping can contain the information of the carrier combinations supported by each grid element or each grid. Additionally, a combination of UE location and measurement reports, and the type of UE may be used in the library for grids for carrier or cell combinations for carrier aggregation. It can be combined with UE's moving speed or the mobility as well, as in aforementioned embodiments.

TABLE 6

| | Carrier | |
|---|---|---|
| | Combination | |
| | supported | Features |
| Grid 1 | A + B + D + E | Set 1 of conditions of |
| | C + G + H | UE location |
| Grid 2 | C + G + H | Set 2 of conditions of |
| | D + G + H | UE location |
| Grid 3 | A + B + D + E | Set 3 of conditions of |
| | A + B + F | UE location |
| | B + E + F + G | |
| Grid 4 | F + I | Set 4 of conditions of |
| | | UE location |
| . . . | . . . | . . . |

Each grid can store a signal strength and/or a signal strength range of one or more carriers that a UE 110 in the grid can detect and perform measurements on. In another embodiment of the present disclosure, the eNB 105 can estimate or predict whether or not the signal strength is higher than a certain threshold. The virtual grid can store the carrier identities if the signal strength for that carrier is above the threshold. In another embodiment, an algorithm can estimate or predict which carrier combinations have signal strengths above a threshold. The virtual grid can store one or more multiple carrier combinations, and can recommend, estimate or predict which cell or carrier combinations for a UE 110 should be used for carrier aggregation.

In one alternative embodiment, carriers may be configured to the UE “blindly” without determining whether the carrier is stronger than a threshold. In this case, the eNB may not need a measurement report from the UE. Measurements may be optimized by an analytics assisted (AA) method in which a list of cells are provided that the UE 110 can perform the measurement for.

Another approach may use mobility support. In using mobility support, a carrier combination may be replaced and the combination may be updated. Once a new combination is chosen, the carrier which is the new combination may be added, and the one in the current combination may be deleted.

In another embodiment filtering may use data analytics. In this case, filtering out carriers is a result of data-analytic based filtering. Filtering out carriers reduces the set of carriers that the UE 110 needs to perform measurements and reporting. This can reduce the measurement and measurement reporting time and energy consumption. If there are multiple options to pick from in the feasible set of combinations, it may be possible to figure out the most effective combination by calculating the highest total effective bandwidth of all of the carriers. This may be also accomplished if the measurements are available.

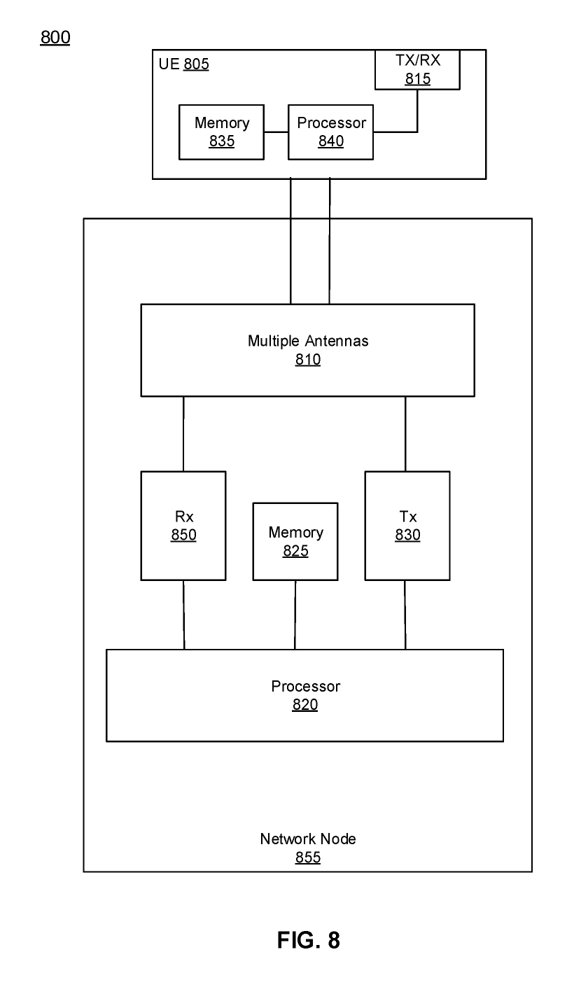

FIG. 8 illustrates an embodiment of a network node 855 used for wireless signal communication between a user equipment 805 and the network node 855 in a wireless communication system 800. Although not depicted, it is appreciated that the communication system may also include or form any type of network, such as the Internet.

The user equipment 805 may include a processor 840, a memory 835, a transceiver 815, and an antenna (not shown). In particular embodiments, some or all of the functionality described above as being provided by mobile communication devices or other forms of UE 2805 may be provided by the UE processor 840 executing instructions stored in the memory 835. Alternative embodiments of the UE 805 may include additional components that may be responsible for providing certain aspects of the UE's functionality, including any of the functionality necessary to support the embodiments of the present disclosure.

The network node 855 comprises multiple antennas 810 configured for beamforming, spatial multiplexing and MIMO transmission. The multiple antennas 810 may include, for example, a multitude of antenna elements, mounted at a distance from each other such that at least some of the antenna elements are able to receive the same signal from the user equipment 805.

The network node 855 is further configured for wireless communication in a wireless communication system and to perform the method and processes according to the disclosed embodiments, and in particular, carrier aggregation of wireless signal communication between a UE 805 and the network node 855 and to select the best carrier combinations. The wireless communication network may be based, for example, on 3GPP LTE. Further, the wireless communication system 800 may be based on FDD or TDD in different embodiments. The network node 85 may comprise a base station or evolved NodeB (eNB) according to some embodiments.

In one embodiment, the radio network node 855 comprises a receiver 850 and transmitter 830 (together, a transceiver), configured for receiving information, such as measurements and measurement reports, from the user equipment UE 805, and a wireless signal from one or more other UEs 805 (not shown).

Further, the radio network node 8558 includes a processor 820 configured for processing and analyzing the received signals and communications from the UE 805. The processor 820 is also configured for configuring carriers to a UE in a carrier aggregation operation based on the communications provided by the UE 805 and information provided by a database storing various virtual grids.

The network node 855 may also include an optional memory 825 (one or more memories), which may comprise a physical device utilized to store data or a program, i.e., a sequence of instructions, on a temporary or permanent basis. According to some embodiments, the memory 825 may comprise integrated circuits comprising silicon-based transistors. Further, the memory 825 may be volatile or non-volatile.

It will become apparent from the description that follows that all or some of the above and below described methods and processes may be performed in the network node 855 and may be implemented through the one or more processors 820, together with a computer program product for performing at least some of described methods and processes.

The schemes described above may be implemented on any general-purpose network component, such as a computer or network component with sufficient processing power, memory resources, and network throughput capability to handle the necessary workload placed upon it.

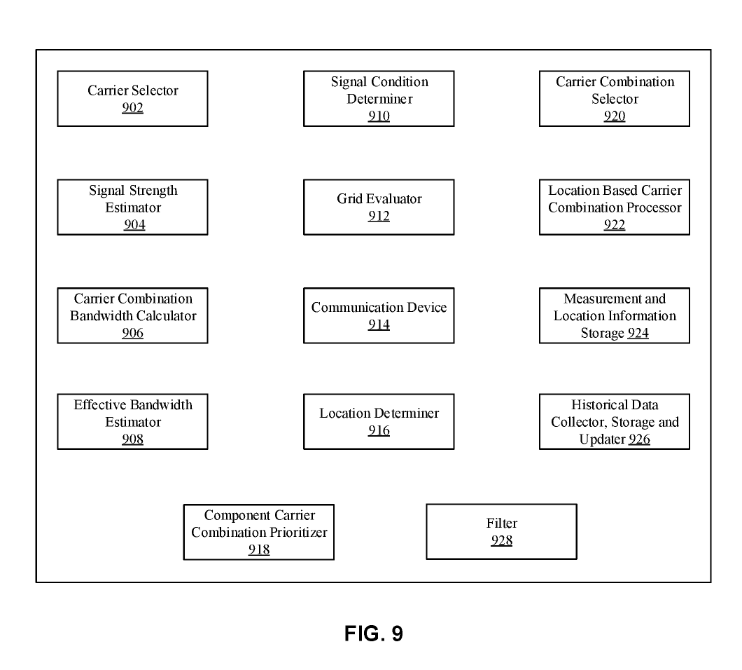

FIG. 9 illustrates a block diagram in accordance with the process depicted in FIGS. 3A-3C and 4. A set of component carriers may be selected in a carrier aggregation operation for a UE in accordance with the various components depicted in FIG. 9. The components include, for example, a carrier selector 902, a signal strength estimator 904, a carrier combination bandwidth calculator 906, an effective bandwidth estimator 908, a signal condition determiner 910, a grid evaluator 912, a communication device 914, a location determiner 916, a component carrier combination prioritizer 918, a carrier combination selector 920, a location based carrier combination processor 922, a measurement and location information storage 924 and a historical collector, storage and updater 924.

A communication device 914 is responsible for receiving a set of feasible component carrier combinations supported by a node and a capability of the UE. At least one of the component carrier combinations based on location information as determined by the location determiner 916 corresponding to the UE are predicted, and signal strength(s) are estimated by the signal strength estimator 904 received from the component carriers to the UE to prioritize the component carrier combinations using the component carrier combination prioritizer 918 from the set of feasible component carrier combinations.

A carrier combination selector 920 is responsible for selecting the component carrier combination having a highest priority, based on the component carrier combination prioritizer 918, in the component carrier combination from the set of prioritized feasible component carrier combinations. The carrier combination bandwidth calculator 906 may then determine the component carrier combination having a highest priority as a component carrier combination with a largest total bandwidth of all the component carriers in the set of component carrier combinations.

Effective bandwidth estimator 908 determines the component carrier combination having a highest priority as a component carrier combination with a largest total effective bandwidth wherein the total effective bandwidth is a total bandwidth of the component carriers in a component carrier combination, where the signal strength to the UE from the component carrier counted in calculating the total effective bandwidth is larger than a threshold.

Filter 928 is responsible for filtering the component carrier combinations supported by the node based on a load of each component carrier in the component carrier combinations supported by the node to remove the component carriers above a load threshold or other factors such as signal strength or pass loss based on historical data.

The predicting may be based on a grid stored in a database which indicates at least one recommended component carrier combination based on the historical data. The grid may be formed, for example, using at least one condition of the signal strength of at least one component carrier and location information using the signal condition determiner 910.

Measurement and location information storage 924 collects measurement information for the component carriers of the component carrier combinations supported by the node and location information for the UEs, and stores the measurement information and the location information in a database.

Additionally, any combination of the historical data collector, storage and updater 926, carrier selector 902, grid evaluator 912 and location based carrier combination processor 922 are responsible for receiving updated measurement information for the component carriers and location information for the UEs, evaluating a grid associated with the component carrier combinations based on the updated measurement information and location information, selecting the component carrier combination for the carrier aggregation for the UEs, monitoring performance of the grid to acquire historical performance data and updating the database with at least one of the updated measurement information and location information and the historical performance data of the grid. The UE may then be instructed to measure the signal strength of at least one component carrier in the set of feasible component carrier combinations and the set of prioritized feasible component carrier combinations.

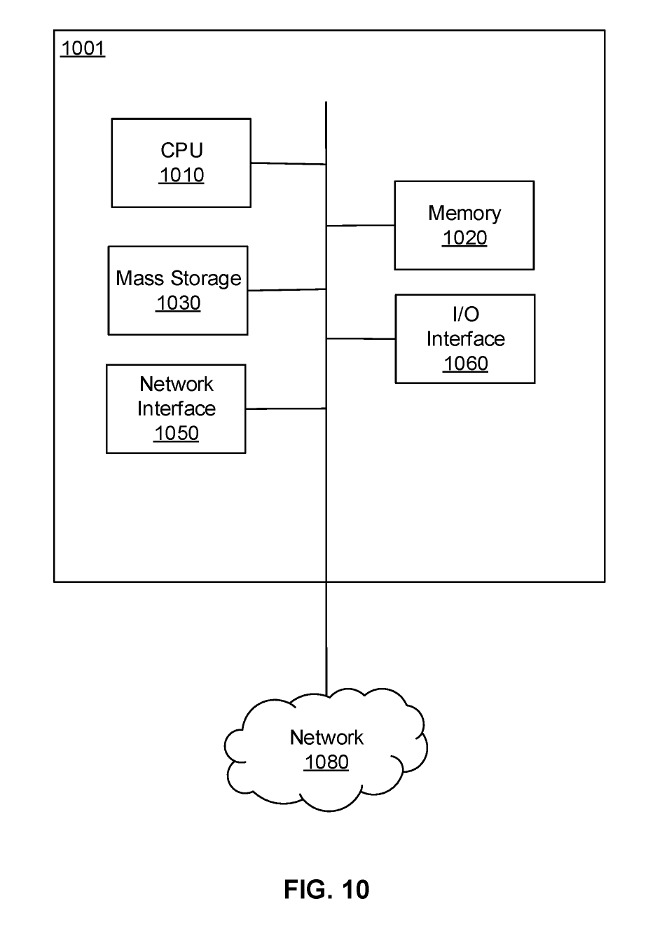

FIG. 10 is a block diagram of a network system that can be used to implement various embodiments. Specific devices may utilize all of the components shown, or only a subset of the components, and levels of integration may vary from device to device. Furthermore, a device may contain multiple instances of a component, such as multiple processing units, processors, memories, transmitters, receivers, etc. The network system may comprise a processing unit 1001 equipped with one or more input/output devices, such as network interfaces, storage interfaces, and the like. The processing unit 901 may include a central processing unit (CPU) 1010, a memory 1020, a mass storage device 1030, and an I/O interface 1060 connected to a bus. The bus may be one or more of any type of several bus architectures including a memory bus or memory controller, a peripheral bus or the like.

The CPU 1010 may comprise any type of electronic data processor. The memory 1020 may comprise any type of system memory such as static random access memory (SRAM), dynamic random access memory (DRAM), synchronous DRAM (SDRAM), read-only memory (ROM), a combination thereof, or the like. In an embodiment, the memory 1020 may include ROM for use at boot-up, and DRAM for program and data storage for use while executing programs. In embodiments, the memory 1020 is non-transitory. The mass storage device 1030 may comprise any type of storage device configured to store data, programs, and other information and to make the data, programs, and other information accessible via the bus. The mass storage device 1030 may comprise, for example, one or more of a solid state drive, hard disk drive, a magnetic disk drive, an optical disk drive, or the like.

The processing unit 1001 also includes one or more network interfaces 950, which may comprise wired links, such as an Ethernet cable or the like, and/or wireless links to access nodes or one or more networks 1080. The network interface 1050 allows the processing unit 1001 to communicate with remote units via the networks 1080. For example, the network interface 1050 may provide wireless communication via one or more transmitters/transmit antennas and one or more receivers/receive antennas. In an embodiment, the processing unit 1001 is coupled to a local-area network or a wide-area network for data processing and communications with remote devices, such as other processing units, the Internet, remote storage facilities, or the like.

There are many benefits to using embodiments of the present disclosure. For example, the amount of measurements, if any at all, that the UE is instructed to make in order to implement a carrier aggregation operation is significantly reduced. Accordingly, the amount of measurements is reduced, thereby saving time allowing for a fast carrier aggregation operation. The reduction in the amount of measurements also reduces the amount of power consumption used for the UE. In addition, there is reduced latency for the carrier aggregation configuration. Further, the bandwidth/throughput for a UE is increased, and the QoS or QoE is increased for the UE also. Moreover, the embodiment of the disclosure provides an overall increase in network efficiency.

The method and apparatus of the present disclosure is advantageous over the prior art. The carrier aggregation operation that is assisted by the analytics component of the present disclosure can be used in LTE, LTE-A, and any CA related wireless systems (4G, 5G, etc.) The product can include the infrastructure, such as eNB, base stations, self-organized networks, radio network controller, etc.

It is understood that the present subject matter may be embodied in many different forms and should not be construed as being limited to the embodiments set forth herein. Rather, these embodiments are provided so that this subject matter will be thorough and complete and will fully convey the disclosure to those skilled in the art. Indeed, the subject matter is intended to cover alternatives, modifications and equivalents of these embodiments, which are included within the scope and spirit of the subject matter as defined by the appended claims. Furthermore, in the following detailed description of the present subject matter, numerous specific details are set forth in order to provide a thorough understanding of the present subject matter. However, it will be clear to those of ordinary skill in the art that the present subject matter may be practiced without such specific details.

In accordance with various embodiments of the present disclosure, the methods described herein may be implemented using a hardware computer system that executes software programs. Further, in a non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

For purposes of this document, each process associated with the disclosed technology may be performed continuously and by one or more computing devices. Each step in a process may be performed by the same or different computing devices as those used in other steps, and each step need not necessarily be performed by a single computing device.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for selecting a set of component carriers in a carrier aggregation operation for a user equipment (UE), the method comprising:
determining a set of feasible component carrier combinations supported by a node and a capability of the UE;
performing one of (a) predicting at least one of the component carrier combinations based on location information corresponding to the UE and (b) estimating one or more signal strengths received from one or more component carriers to the UE to prioritize the component carrier combinations from the set of feasible component carrier combinations; and
selecting the component carrier combination having a highest priority in the component carrier combination from the set of prioritized feasible component carrier combinations.

2. The method of claim 1, wherein the component carrier combination having a highest priority is a component carrier combination with a largest total bandwidth of all the component carriers in the set of component carrier combinations.

3. The method of claim 1, wherein the component carrier combination having a highest priority is a component carrier combination with a largest total effective bandwidth wherein the total effective bandwidth is a total bandwidth of the component carriers in a component carrier combination, where the signal strength to the UE from the component carrier counted in calculating the total effective bandwidth is larger than a threshold.

4. The method of claim 1, further comprising:
filtering the one or more component carrier combinations supported by the node based on a load of each component carrier in the one or more component carrier combinations supported by the node to remove the one or more component carriers above a load threshold.

5. The method of claim 1, wherein the predicting is based on a grid stored in a database which indicates at least one recommended component carrier combination, wherein the grid is formed using at least one condition of the signal strength of at least one component carrier and location information.

6. The method of claim 1, further comprising:
collecting measurement information for one or more component carriers of the one or more component carrier combinations supported by the node and location information for one or more UEs; and
storing the measurement information and the location information in a database.

7. The method of claim 6, further comprising:
receiving updated measurement information for the one or more component carriers and location information for one or more UEs;
evaluating a grid associated with the one or more component carrier combinations based on the updated measurement information and location information;
selecting the component carrier combination for the carrier aggregation for the one or more UEs;
monitoring performance of the grid to acquire historical performance data; and
updating the database with at least one of the updated measurement information and location information and the historical performance data of the grid.

8. The method of claim 1, further comprising instructing the UE to measure the signal strength of at least one component carrier in the set of feasible component carrier combinations and the set of prioritized feasible component carrier combinations.

9. The method of claim 1, wherein the determining a set of feasible component carrier combinations is based on at least one of: a carrier loading, the UE capability, the node capability, at least one of a signal strength and a path loss for at least a carrier and a grid, a carrier bandwidth, a total bandwidth for aggregated carriers and historical signal strength data for a carrier.

10. A node configured to perform a carrier aggregation operation, the node comprising:
a receiver configured to receive a capability of a user equipment (UE); and
one or more processors in communication with the receiver and storing instructions in a non-transitory memory storage, wherein the one or more processors execute the instructions to:
determine the set of feasible component carrier combinations supported by the node and the capability of the UE;
perform one of (a) predicting at least one of the component carrier combinations based on location information corresponding to the UE and (b) estimating one or more signal strengths received from one or more component carriers to the UE to prioritize the component carrier combinations from the set of feasible component carrier combinations; and
select the component carrier combination having a highest priority in the component carrier combination from the set of prioritized feasible component carrier combinations.

11. The node of claim 10, wherein the component carrier combination having a highest priority is a component carrier combination with a largest total bandwidth of all the component carriers in the set of component carrier combinations.

12. The node of claim 10, wherein the component carrier combination having a highest priority is a component carrier combination with a largest total effective bandwidth wherein the total effective bandwidth is a total bandwidth of the component carriers in a component carrier combination, where the signal strength to the UE from the component carrier counted in calculating the total effective bandwidth is larger than a threshold.

13. The node of claim 10, wherein the one or more processors executes the instructions to:
filter the one or more component carrier combinations supported by the node based on a load of each component carrier in the one or more component carrier combinations supported by the node to remove the one or more component carriers above a load threshold.

14. The node of claim 10, wherein the predicting is based on a grid stored in a database which indicates at least one recommended component carrier combination.

15. The node of claim 14, wherein the grid is formed using at least one condition of the signal strength of at least one component carrier and location information.

16. The node of claim 10, wherein measurement information for one or more component carriers of the one or more component carrier combinations supported by the node and location information for one or more UEs is collected and the measurement information and the location information is stored in a database.

17. The node of claim 16, wherein the one or more processors executes the instructions to:
receive updated measurement information for the one or more component carriers and location information for the one or more UEs;
evaluate a grid associated with the one or more component carrier combinations based on the updated measurement information and location information;
select the component carrier combination for the carrier aggregation for the one or more UEs;
monitor performance of the grid to acquire historical performance data; and
update the database with at least one of the updated measurement information and location information and the historical performance data of the grid.

18. The node of claim 10, wherein the one or more processors executes the instructions to instruct the UE to measure the signal strength of at least one component carrier in the set of feasible component carrier combinations and the set of prioritized feasible component carrier combinations.

19. A non-transitory computer-readable medium storing computer instructions for selecting a set of component carriers in a carrier aggregation operation for a user equipment (UE) in a communication network, that when executed by one or more processors, perform the steps of:
determining a set of feasible component carrier combinations supported by a node and a capability of the UE;
performing one of (a) predicting at least one of the component carrier combinations based on location information corresponding to the UE and (b) estimating one or more signal strengths received from one or more component carriers to the UE to prioritize the component carrier combinations from the set of feasible component carrier combinations; and
selecting the component carrier combination having a highest priority in the component carrier combination from the set of prioritized feasible component carrier combinations.

20. The non-transitory computer-readable medium of claim 19, wherein the predicting is based on a grid stored in a database which indicates at least one recommended component carrier combination.
